(19) United States
(12) Patent Application Publication
(10) Pub. No.: US 2026/0203460 A1
(43) Pub. Date: Jul. 16, 2026

(54) TEMPERATURE CONTROL DEVICE DESIGN METHOD AND TEMPERATURE CONTROL DEVICE

(71) Applicants: Kagoshima University, Kagoshima (JP); KYOCERA Corporation, Kyoto (JP)

(72) Inventors: Kei MIZUTA, I, Kagoshima (JP); Yutaka NABESHIMA, Kyoto (JP)

(21) Appl. No.: 19/133,688

(22) PCT Filed: Nov. 22, 2023
(86) PCT No.: PCT/JP2023/042078

§ 371 Date: May 28, 2025

(30) Foreign Application Priority Data
Nov. 28, 2022 (JP) 2022-189258

(51) Int. Cl. G06F 30/17

(52) U.S. Cl. CPC G06F 30/17

(57) ABSTRACT

In the design method of a temperature control device, a size of the heat diffusion plate (10) and the heat source (11), and heat conductivity and an overall heat transfer coefficient of the heat diffusion plate (10) are decided based on a calculation equation indicating a relationship among an ambient temperature around the control subject (CO), a target temperature of the control subject (CO), an input heat amount from the heat source (11) to the heat diffusion plate (10), the size of the heat diffusion plate (10) and the heat source (11), the heat conductivity and the overall heat transfer coefficient of the heat diffusion plate (10), and variations in temperature on the first surface (S1).

### TECHNICAL FIELD

The present disclosure relates to a design method of a temperature control device and the temperature control device.

### BACKGROUND ART

A physical property value of an object and a reaction between objects have temperature dependence. Thus, in a processing step of executing some sort of processing on the entire surface of an object spreading in a surface direction, variations in temperature in a surface of an object being a processing subject need to be reduced in order to reduce variations in a physical property value of the object and a reaction rate of a reaction field of a reaction occurring in the processing. Thus, for example, an assembly in which variations in temperature in a wafer surface are reduced by incorporating a thermal phase diffuser into a pedestal for supporting a wafer in a semiconductor manufacturing step is disclosed (see Patent Literature 1).

### CITATION LIST

### Patent Literature

Patent Literature 1: Unexamined Japanese Patent Application Publication (Translation of PCT Application) No. 2020-526012

### SUMMARY OF INVENTION

### Technical Problem

In the semiconductor manufacturing step described above, variations in a reaction rate of a reaction field in the wafer surface have a permissible value, and there is also a permissible value corresponding to variations in temperature in the wafer surface. In the assembly described above, variations in temperature of the wafer can be reduced. However, Patent Literature 1 described above does not disclose how to suppress variations in temperature in the wafer surface within the permissible value. In order to set variations in temperature within the permissible value, control capacity of a temperature control device that controls temperature in the wafer surface needs to be designed in such a way as to satisfy the permissible value.

The present disclosure has been made under the circumstances described above, and has an objective to provide a design method of a temperature control device and the temperature control device that can suppress, within a permissible value, variations in temperature in a surface of a control subject spreading in a surface direction.

### Solution to Problem

In order to achieve the aforementioned objective, a design method of a temperature control device according to a first aspect of the present disclosure is a design method of a temperature control device, the temperature control device including a heat diffusion plate that is a member provided with a first surface facing a control subject and a second surface being parallel to the first surface and facing in an opposite direction, and diffuses heat in a surface direction of the first surface, and a heat source that is thermally bonded to the heat diffusion plate on the second surface, and performs heating or heat-absorbing on the heat diffusion plate, the design method including:
deciding a size of the heat diffusion plate and the heat source, and heat conductivity and an overall heat transfer coefficient of the heat diffusion plate, based on a calculation equation indicating a relationship among an ambient temperature around the control subject, a target temperature of the control subject, an input heat amount from the heat source to the heat diffusion plate, the size of the heat diffusion plate and the heat source, the heat conductivity and the overall heat transfer coefficient of the heat diffusion plate, and variations in temperature on the first surface, in such a way that a difference between a maximum temperature and a minimum temperature of a portion of the first surface in contact with the control subject when the ambient temperature, the target temperature, and the input heat amount are set as given design conditions falls within a permissible value of in-surface variations in temperature of the control subject.

In this case, the heat diffusion plate may include
a housing that has a hermetically sealed internal space, and is made of any of ceramics, a ceramics composite material, and an inorganic substance except for metal, and
a working fluid that is located in the internal space, circulates in the internal space in the surface direction of the first surface while repeating vaporization by heat reception and condensation by heat radiation, and diffuses heat in the surface direction of the first surface.

A heat expansion coefficient of a substance of the housing may be equal to or less than 8.0×10⁻⁶ [1/K].

The design method may further include:
setting a permissible value of in-surface variations in temperature of the control subject, based on a temperature characteristic of a physical property value of the control subject or a characteristic of a reaction rate in the surface of the control subject when the control subject is a reaction field.

The heat source may be any of a heater, a Peltier element, and a cold plate.

The heat source and the heat diffusion plate may be integral in the second surface.

The heat source may be incorporated in the heat diffusion plate.

The heat source and the heat diffusion plate may each have a disk-shaped outer shape and may also be disposed concentrically, and
a radius of the heat source may be smaller than a radius of the heat diffusion plate.

A temperature control device according to a second aspect of the present disclosure is a temperature control device being designed by using the design method according to the first aspect.

### Advantageous Effects of Invention

According to the present disclosure, a size of a heat source and a heat diffusion plate, and heat conductivity and an overall heat transfer coefficient of the heat diffusion plate can be decided in such a way that a difference between a maximum temperature and a minimum temperature on a first surface in contact with a control subject is set less than a permissible value of in-surface variations in temperature of the control subject, and thus variations in temperature in a surface of the control subject can be suppressed within the permissible value.

### BRIEF DESCRIPTION OF DRAWINGS

FIG. 1 is a side view and a bottom view of a temperature control device according to an embodiment of the present disclosure;

FIG. 2 is a schematic diagram illustrating an internal structure of a heat diffusion plate;

FIG. 3A is a graph illustrating a temperature characteristic of a reaction rate;

FIG. 3B is a graph illustrating a temperature characteristic of a physical property value;

FIG. 4 is a schematic diagram illustrating a way of spreading heat energy in a surface direction in the heat diffusion plate;

FIG. 5 is a graph illustrating a dimensionless temperature distribution in a radial direction of the heat diffusion plate;

FIG. 6A is a block diagram illustrating a hardware configuration of an information processing device;

FIG. 6B is a flowchart illustrating of design processing by the information processing device;

FIG. 7 is a graph illustrating a temperature characteristic of heat conductivity of the heat diffusion plate;

FIG. 8A is a schematic diagram illustrating a first modified example of a configuration of the temperature control device;

FIG. 8B is a schematic diagram illustrating a second modified example of the configuration of the temperature control device;

FIG. 9 is a side view illustrating a configuration of a substrate holding device in which the temperature control device is incorporated; and

FIG. 10 is a perspective view illustrating the temperature control device having a columnar shape.

### DESCRIPTION OF EMBODIMENTS

Hereinafter, embodiments of the present disclosure are described in detail with reference to drawings. The same or equivalent portion is denoted by the same reference sign in each of the drawings.

### [Basic Configuration of Temperature Control Device]

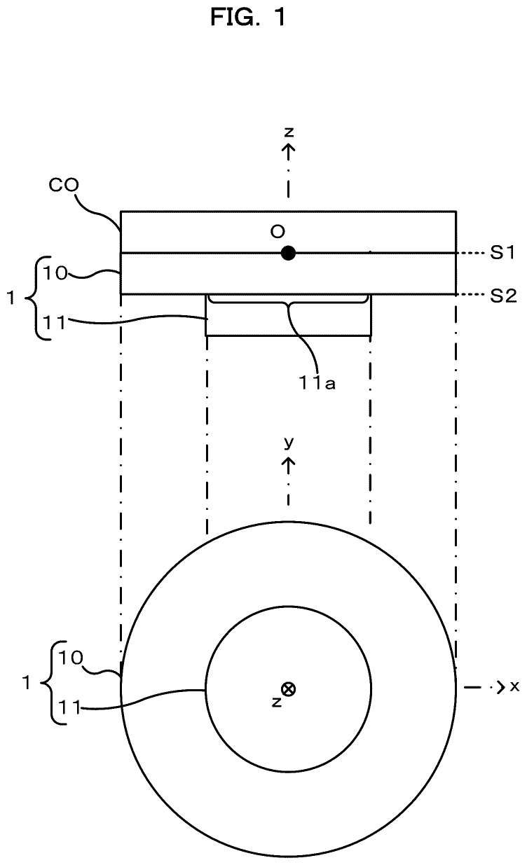

First, a basic configuration of a temperature control device being a design subject of a design method according to the present embodiment is described. As illustrated in FIG. 1, a temperature control device 1 controls a temperature of a control subject CO. The control subject CO represents, for example, an object or a reaction field having a disk shape. The temperature control device 1 includes a heat diffusion plate 10 whose outer shape is a disk shape, and a heat source 11 whose outer shape is similarly a disk shape.

In the heat diffusion plate 10, a surface facing a +z direction, that is, a surface facing the control subject CO of a circular surface in which a z-axis direction is a normal direction is assumed to be a first surface S1. A surface facing a −z direction in which the z-axis direction is the normal direction is assumed to be a second surface S2. The first surface S1 and the second surface S2 are main surfaces on the front and back of the heat diffusion plate 10 that are parallel to each other and face in opposite directions, and a distance between the first surface S1 and the second surface S2 is a plate thickness of the heat diffusion plate 10.

The heat diffusion plate 10 and the heat source 11 are disposed concentrically together with the control subject CO with a z axis as the center. In the present embodiment, a radius of the heat diffusion plate 10 is assumed to be the same as a radius of the control subject CO, and a radius of the heat source 11 is assumed to be smaller than the radius of the heat diffusion plate 10.

The heat diffusion plate 10 is disposed on the +z side of the heat source 11 in such a way as to be in surface contact with and thermally bonded to the heat source 11 on the second surface S2. The control subject CO is disposed on the +z side of the heat diffusion plate 10 in such a way as to be in surface contact with the heat diffusion plate 10 on, for example, the first surface S1. The heat source 11 is in surface contact with the heat diffusion plate 10 in a circular region 11a (region having the same radius as the heat source 11) in the second surface S2.

The heat source 11 performs heating or heat-absorbing on the heat diffusion plate 10. The heat diffusion plate 10 diffuses heat in a surface direction of the first surface S1. The heat diffusion plate 10 having a temperature made uniform in the surface direction of the first surface S1 by heating or heat-absorbing by the heat source 11 performs heating or heat-absorbing on the control subject CO.

When the heat source 11 heats the heat diffusion plate 10, heat from the heat source 11 is applied to the heat diffusion plate 10 via the circular region 11a of the second surface S2. The heat diffusion plate 10 diffuses the heat in the surface direction of the first surface S1, that is, a radial direction with the z-axis direction as the center. The heat diffused in the radial direction is transmitted to the control subject CO. A temperature of the control subject CO is controlled to a target temperature by the transmitted heat.

When the heat source 11 cools the heat diffusion plate 10, a temperature of the heat diffusion plate 10 is reduced by heat-absorbing by the heat source 11 via the circular region 11a of the second surface S2. By a reduction in temperature in the region 11a, a coolant moves in the radial direction in the heat diffusion plate 10, and a temperature of the first surface S1 is evenly reduced. In this way, the heat diffusion plate 10 uniformly cools the control subject CO by the entire first surface S1.

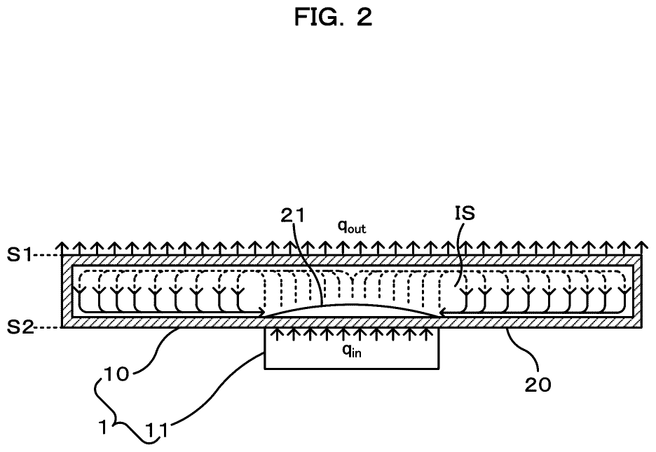

As illustrated in FIG. 2, the heat diffusion plate 10 includes a housing 20 having a hermetically sealed internal space IS, and a working fluid 21 as the coolant enclosed in the internal space IS. In the internal space IS, the working fluid 21 in a liquefied state and the vaporized working fluid 21 coexist in a state of maintaining an equilibrium state. The working fluid 21 in the liquefied state is present directly above the heat source 11. The working fluid 21 is vaporized by the heat transmitted from the heat source 11, transmits (radiates) the heat to the housing 20 while moving in the surface direction of the first surface S1 in the internal space IS, and gradually condenses. The condensed working fluid 21 is configured to return to the heat source 11 by capillary force of a capillary flow path (not illustrated) provided in the internal space IS. In this way, the working fluid 21 circulates in the internal space IS while repeating vaporization by heat reception and condensation, and diffuses the heat in the surface direction of the first surface S1. Note that the working fluid 21 can be, for example, pure water, but may be an organic substance and may be a mixture of an organic substance and water.

The housing 20 is made of a low-heat expansion material. Examples of such a substance include, for example, ceramics. As ceramics, for example, alumina, silicon nitride (SN), aluminum nitride (AlN), Y₂O₃, zirconia, cordierite, diamond as a single crystal material, sapphire, and the like can be used, which are not limited thereto. Examples of such substances include, for example, a ceramics composite material. As a ceramics composite material, SiSiC, CMC, and the like can be used, which are not limited thereto. As a substance other than the substances described above, there are glass, carbon, graphite, and silicon, which are not limited thereto. In other words, the housing 20 is made of any of ceramics, a ceramics composite material, and an inorganic substance except for metal.

A heat expansion coefficient of each substance is indicated in the following table.

TABLE 1

| | | | HEAT EXPANSION |
|---|---|---|---|
| MATERIAL | TEMPERATURE | | COEFFICIENT |
| COPPER | 20-300° | C. | 16.8 × 10⁻⁶/K |
| SUS304 | 0-100° | C. | 17.3 × 10⁻⁶/K |
| A6063 | 20-100° | C. | 23.4 × 10⁻⁶/K |
| ALUMINA | 40-400° | C. | 7.2 × 10⁻⁶/K |
| SILICON NITRIDE | 40-400° | C. | 2.8 × 10⁻⁶/K |
| SODA-LIME PLATE GLASS | RT-350° | C. | 8.5 × 10⁻⁶/K |
| QUARTZ (SiO₂) | RT-300° | C. | 0.5 × 10⁻⁶/K |
| Si | RT-1000° | C. | 3.9 × 10⁻⁶/K |
| GRAPHITE | RT-450° | C. | 3.2 × 10⁻⁶/K |
| Si—SiC | RT-1000° | C. | 4.2 × 10⁻⁶/K |

As a substance used as a material of the housing 20, a substance having a heat expansion coefficient smaller than that of metal such as copper is selected. In a case where a substance having a small heat expansion coefficient is used as a material of the housing 20, when the control subject CO or the heat source 11 generates heat, deformation of the heat diffusion plate 10 can be reduced, and a numerical change of an overall heat transfer coefficient h can be reduced, and thus the overall heat transfer coefficient h is easily decided. In the present embodiment, a substance having a heat expansion coefficient of 8.0×10⁻⁶[1/K] or less is desirably selected as a material of the housing 20.

When the control subject CO is heated, the heat source 11 can be a heater. Furthermore, a component including an element, a device, and the like that generate heat by operating may be used as the heat source 11, and a component in which gas, liquid, and the like accompanied by heat circulate may be used as the heat source 11. Further, a high frequency induction heating device, a plasma heating device, and a laser heating device may be used as the heat source 11. In the temperature control device 1 according to the present embodiment, a kind of the heat source 11 is not limited, and various heat sources 11 can be adopted.

When the control subject CO is cooled, the heat source 11 can be a Peltier element or a cold plate. Furthermore, as the heat source 11, a water-cooled component and a component using a heat exchanger can be adopted. In the temperature control device 1 according to the present embodiment, a kind of the heat source 11 is not limited, and various heat sources 11 can be adopted.

### [Effect of Configuration of Temperature Control Device 1]

When the heat source 11 is solid, the heat source 11 and the control subject CO are indirectly connected via the heat diffusion plate 10. When the heat source 11 and the control subject CO are directly connected, there is a difference in a heat transfer speed between a portion in contact with the heat source 11 and a portion not in contact, and, as a result, ununiformity occurs in a temperature distribution of the control subject CO.

It is also conceivable that the heat source 11 having the same radius as a radius of the control subject CO is directly connected to the control subject CO. However, in this case, when the heat source 11 is, for example, a heater, electrical resistance locally changes due to temperature unevenness in the heater, and thus sufficient temperature smoothness is difficult to achieve. When the heat source 11 is, for example, a Peltier module, a plurality of elements including a heat transfer surface smaller than the entire module is disposed on a surface, and each of the elements performs heating or heat-absorbing. However, there is a gap between the elements, and a small heat diffusion plate is disposed on the heat transfer surface in order to reduce an influence of the gap. The heat diffusion plate is far smaller than the heat diffusion plate 10. The heat diffusion plate is made of copper, and thus has insufficient heat diffusion performance. Thus, ununiformity of a heat flux between a place with the element and a place without the element cannot be sufficiently reduced, and, as a result, temperature smoothness sufficient for a permissible value of temperature unevenness is difficult to achieve. In this way, when the heat source 11 and the control subject CO are directly connected, it is difficult to make a heat transfer speed uniform on the entire surface of the control subject CO in order to achieve a smooth temperature distribution sufficient for a permissible value of temperature unevenness. In order to reduce ununiformity of the heat transfer speed, the temperature control device 1 has the configuration for connecting the heat source 11 via the heat diffusion plate 10.

Note that, when the heat source 11 is used for cooling the control subject CO, a fin (not illustrated) may be provided on the heat source 11.

### [Design Method of Temperature Control Device]

A design method of the temperature control device 1 according to the present embodiment is described. In the design method, the temperature control device 1 is designed in such a way that variations in in-surface temperature of the first surface S1 of the heat diffusion plate 10 in contact with the control subject CO are set to be equal to or less than a permissible value.

### [Decision on Permissible Value]

In the design method, first, a permissible value ΔT_{C} of variations in temperature of the control subject CO and the first surface S1 of the heat diffusion plate 10 needs to be decided. The permissible value ΔT_{C} is determined based on a temperature characteristic of the control subject CO.

[Permissible Value ΔT_{C} Obtained from Variations in Reaction]

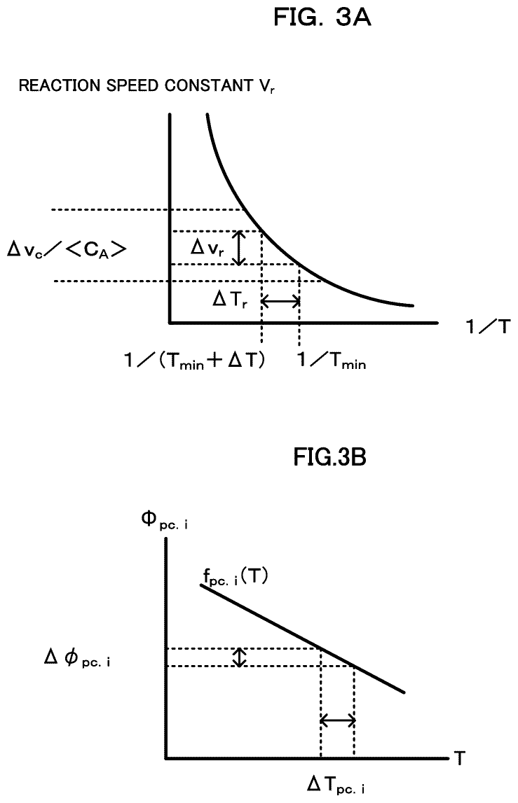

The control subject CO is assumed to be a reaction field in which substances are caused to react. In the reaction field spreading in terms of a surface, a reaction rate needs to be made uniform in the surface, that is, in-surface variations in a reaction rate need to be suppressed to less than a permissible value. A reaction rate of the control subject CO in the surface is assumed to be v, and a permissible value of variations in the reaction rate v is assumed to be Δv_{c}. Dependence of the control subject CO on a temperature T of a reaction rate constant vᵣ is given by the following equation (1) by the Arrhenius law. FIG. 3A illustrates a curve indicating the equation (1).

$$\begin{matrix}[ Mathematical 1 ] & \\ {v}_{r} = {A}_{r} exp ( - \frac{{E}_{a}}{RT} ) & ( 1 )\end{matrix}$$

Herein, Aᵣ is a frequency factor, Eₐ [J·mol⁻¹] is activation energy, R [J·K⁻¹·mol⁻¹] is a gas constant, and T [K] is a temperature of the control subject CO.

A unit of the frequency factor Aᵣ changes by an order of a reaction. For example, on an assumption that a reaction assumed herein is a first-order reaction, a unit of the frequency factor Aᵣ is [S⁻¹]. At this time, on an assumption that a concentration of a reactant is C_{A} [mol·m⁻³], the reaction rate v is represented by the following equation.

$$\begin{matrix}[ Mathematical 2 ] & \\ v = {v}_{r} {C}_{A} & ( 2 )\end{matrix}$$

Variations Δv in the reaction rate v are represented by the following equation.

$$\begin{matrix}[ Mathematical 3 ] & \\ Δ v = Δ ( {v}_{r} {C}_{A} ) = Δ {v}_{r} 〈 {C}_{A} 〉 + 〈 {v}_{r} 〉 Δ {C}_{A} + Δ {v}_{r} Δ {C}_{A} & ( 3 )\end{matrix}$$

Herein, <vᵣ> and <C_{A}> are average values in a surface of the reaction rate constant vᵣ and the concentration C_{A} in a radius r, respectively. On an assumption that second-order minute amounts Δvᵣ and ΔC_{A} are smaller than others and small to a negligible degree, the following equation is acquired by the equation (3).

$$\begin{matrix}[ Mathematical 4 ] & \\ Δ v = Δ {v}_{r} 〈 {C}_{A} 〉 + 〈 {v}_{r} 〉 Δ {C}_{A} & ( 4 )\end{matrix}$$

A permissible value of variations in a reaction ratio in a reaction field is assumed to be Δη. In this case, the variations Δv in the reaction rate v need to satisfy a condition indicated by the following equation.

$${\int }_{0}^{{t}_{p}} Δ vdt < Δ η \qquad [ Mathematical 5 ]$$

tₚ is a reaction time. The variations Δv in the reaction rate v satisfying the condition equation are the permissible value Δv_{c} of the variations in the reaction rate v in the equation (4) described above. Therefore, the following equation is acquired by the equation (4) described above.

$$Δ v = Δ {v}_{r} 〈 {C}_{A} 〉 + 〈 {v}_{r} 〉 Δ {C}_{A} < Δ {v}_{c} \qquad [ Mathematical 6 ]$$

The equation is converted as follows.

$$[ Mathematical 7 ]$$

$$Δ {v}_{r} + 〈 Δ {v}_{r} 〉 \frac{Δ {C}_{A}}{〈 {C}_{A} 〉} < \frac{Δ {v}_{c}}{〈 {C}_{A} 〉} \qquad ( 5 )$$

On an assumption that the ununiformity ΔC_{A} of the concentration in the surface with respect to the average concentration <C_{A}> is sufficiently small, the following equation is acquired by the equation (5).

$$[ Mathematical 8 ]$$

$$Δ {v}_{r} < \frac{Δ {v}_{c}}{〈 {C}_{A} 〉} \qquad ( 6 )$$

Herein, on an assumption that a minimum value of a temperature in the surface of the heat diffusion plate 10 is Tₘᵢₙ [K], and a maximum value is Tₘₐₓ [K], ΔT=Tₘₐₓ−Tₘᵢₙ as illustrated in FIG. 3A, and

$$[ Mathematical 9 ]$$

$$Δ {v}_{r} = {A}_{r} \{ exp ( - \frac{{E}_{a}}{R ( {T}_{min} + Δ T )} ) - exp ( \frac{{E}_{a}}{{RT}_{min}} ) \} \qquad ( 7 )$$

is derived from the equation (1). Thus, a condition in which the variations ΔT in the temperature T in the surface needs to satisfy is given by the following equation.

$$[ Mathematical 10 ]$$

$${A}_{r} \{ exp ( - \frac{{E}_{a}}{R ( {T}_{min} + Δ T )} ) - exp ( \frac{{E}_{a}}{{RT}_{min}} ) \} < \frac{Δ {v}_{C}}{〈 {C}_{A} 〉} \qquad ( 8 )$$

Herein, an upper limit value of ΔT satisfying the equation (8) is a permissible value ΔTᵣ of temperature variations. A range of ΔT satisfying the equation (8) can be decided by using a solution method such as a bisection method. Therefore, by the procedures described above, the permissible value ΔTᵣ of the temperature variations when the control subject CO is the reaction field can be decided.

As illustrated in FIG. 3B, temperature dependence of a physical property value Φ_{pc.i}(pc.i=1, 2, 3, . . . , n: n is any integer) of a substance included in the control subject CO is assumed to be given by the following equation (9).

$$[ Mathematical 11 ]$$

$${ϕ}_{pc , i} = {f}_{pc . i} ( T ) \qquad ( 9 )$$

Herein, f_{pc.i}(T) is a function of a temperature T [K]. One example of f_{pc.i}(T) is illustrated in FIG. 3B. On an assumption that a permissible value (minute amount) of in-surface variations in the physical property value Φₚᵢ is ΔΦ_{pc.i}, a permissible value ΔT_{pc.i}; of variations in temperature for satisfying ΔΦ_{pc.i} needs to satisfy the following condition.

$$[ Mathematical 12 ]$$

$${f}_{pc . i} ( Δ {T}_{pc . i} ) < {Δϕ}_{pc . i} \qquad ( 10 )$$

Therefore, among the permissible value ΔTᵣ of variations in temperature decided from the permissible value Δvᵣ being the minute amount of the variations Δv in the reaction rate v, and the permissible value ΔT_{pc.i} (pc.i=1, 2, 3, . . . , n) of variations in temperature decided from the permissible value of variations in the physical property value, a smallest value is the permissible value ΔT_{c} of variations in the in-surface temperature T of the first surface S1 on the control subject CO. Herein, the permissible value of variations in the in-surface temperature T of the first surface S1 can be decided as ΔT_{C}.

Note that the temperature T [K] indicated in the equations (1) to (10) described above is a temperature of the control subject CO. When a thickness of the control subject CO is thin to a negligible degree, a temperature of the control subject CO and a temperature of the first surface S1 of the heat diffusion plate 10 are almost the same. In a case where a thickness of the control subject CO is not negligible, the following relationship holds true when a heat transfer coefficient in an opposite surface of the control subject CO to the heat diffusion plate 10 is set as Uₜₒₚ, a temperature of the heat diffusion plate 10 is set as T, a temperature of the control subject CO on an opposite side to the heat diffusion plate 10 is set as Tₜₒₚ, heat conductivity of the control subject CO in a thickness direction is set as kₜ, a thickness of the control subject CO is δt, and a place of heat conduction in the heat diffusion plate 10 and a place of heat transmission to the control subject CO are coupled.

$$[ Mathematical 13 ]$$

$${k}_{t} \frac{\vert T - {T}_{tap} \vert}{{δ}_{t}} = {U}_{top} \vert {T}_{top} - {T}_{∞} \vert$$

Thus, for example, when T>Tₜₒₚ and Tₜₒₚ>T_{∞}, the following equation is acquired for Tₜₒₚ.

$$[ Mathematical 14 ]$$

$$T - {T}_{top} = \frac{{v}_{top} {δ}_{t}}{{k}_{t}} ( {T}_{top} - {T}_{∞} )$$

The equation is converted as follows.

$$[ Mathematical 15 ]$$

$${T}_{top} = \frac{1}{1 + \frac{{v}_{top} {δ}_{t}}{{k}_{t}}} ( T + \frac{{v}_{top} {δ}_{t}}{{k}_{t}} {T}_{∞} )$$

When a thickness of the control subject CO is not negligible, T [K] in the equations (1) to (10) described above needs to be calculated on an assumption that T [K] corresponds to Trop.

### [Design Parameter of Temperature Control Device]

A design parameter related to a size and heat transfer of the temperature control device 1 satisfying the permissible value ΔT_{C} of variations in the in-surface temperature T of the first surface S1 can be decided as follows, for example.

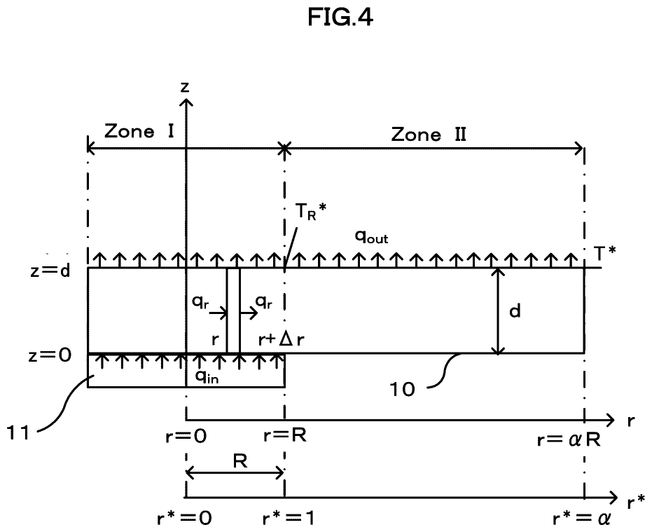

As illustrated in FIG. 4, a minute section between a position r in the radial direction with reference to a central point in the heat diffusion plate 10 and a position r+Δr is considered. The minute section constitutes a shell having a double cylindrical shape. A plate thickness of the heat diffusion plate 10 is assumed to be d. In the shell, it is assumed that a heat amount qᵣ enters from the position r by heat conduction in a direction of the radius r, and the heat amount qᵣ exits from the position r+Δr. Further, an input heat amount input from the heat source 11 is assumed to be qᵢₙ, and a heat amount from the heat diffusion plate 10 to the control subject CO is assumed to be qₒᵤₜ. In the shell, it is assumed that heat is transmitted from a section in contact with the heat source 11 in the thickness direction, and the heat amount exits from a section in contact with the control subject CO. In this case, a governing equation of storage of heat energy of the shell in a stationary state can be prescribed as follows.

$$[ Mathematical 16 ]$$

$${( 2 π {rdq}_{r} ) {\vert}_{r} - ( 2 π {rdq}_{r} ) \vert}_{r + Δ r} + 2 π r Δ r ( {q}_{in} - {q}_{out} ) = 0 \qquad ( 11 )$$

The following equation is acquired by dividing both sides of the above-described equation by 2 πrdΔr and setting Δr close to 0.

$$[ Mathematical 17 ]$$

$$\frac{d}{dr} ( {rq}_{r} ) + \frac{r}{d} ( {q}_{in} - {q}_{out} ) = 0 \qquad ( 12 )$$

According to the Fourier's law related to heat conduction, qᵣ [W·m⁻²] is as follows. kᵣ is heat conductivity in the radial direction.

$$[ Mathematical 18 ]$$

$${q}_{r} = - {k}_{r} \frac{dT}{dr} \qquad ( 13 )$$

According to the Newton's law, qₒᵤₜ [W·m⁻²] is as follows.

$$[ Mathematical 19 ]$$

$${q}_{out} = h ( T - {T}_{∞} ) \qquad ( 14 )$$

h [W·m⁻²·K⁻¹] is an overall heat transfer coefficient with reference to the first surface S1 of the heat diffusion plate 10. T∞ is a reference temperature being a reference of heat diffusion. When there is the control subject CO, an ambient temperature around the control subject CO can be set as the reference temperature T∞. The equation (12) described above is as follows on an assumption that the heat conductivity kᵣ [W·m⁻¹·K⁻¹] and the overall heat transfer coefficient h [W·m⁻²·K⁻¹] are fixed in the heat diffusion plate 10.

$$[ Mathematical 20 ]$$

$$r \frac{{d}^{2} T}{{dr}^{2}} + \frac{dT}{dr} + r \frac{b}{{k}_{r} d} ( T - {T}_{∞} - \frac{{q}_{in}}{h} ) \qquad ( 15 )$$

Herein, a surface temperature of the control subject CO in the radius r [m] of the first surface S1 is assumed to be T*(r) [K]. The surface temperature T*(r) [K] is defined as follows.

$$[ Mathematical 21 ]$$

$${T}^{*} ( r ) = T ( r ) - {T}_{∞} - \frac{{q}_{in}}{h} \qquad ( 16 )$$

Herein, T(r) [K] is a temperature of the heat diffusion plate 10 in the radius r, and qᵢₙ [W·m⁻²] is a heat flux in input heat to the heat diffusion plate 10.

On an assumption that an ambient temperature T∞ [K] around the control subject CO and qᵣ [W·m⁻²] are also fixed, the following equation is acquired from the equation (15).

$$\begin{matrix}[ Mathematical 22 ] & \\ r \frac{{d}^{2} {T}^{*}}{{dr}^{2}} + \frac{{dT}^{*}}{dr} + r \frac{h}{{k}_{r} d} {T}^{*} & ( 17 )\end{matrix}$$

A dimensionless temperature θ [−] in which a temperature in an end portion (r=R) of the heat source 11 is T*_{R} [K] and T*_{R} [K] is a reference is defined by the following equation.

$$\begin{matrix}[ Mathematical 23 ] & \\ Θ = \frac{{T}^{*}}{{T}_{R}^{*}} & ( 18 A )\end{matrix}$$

With reference to a radius R [m] of the heat source 11, a dimensionless radius r* is defined in the following equation.

$$\begin{matrix}[ Mathematical 24 ] & \\ {r}^{*} = \frac{r}{R} & ( 18 B )\end{matrix}$$

The following equation is acquired from the equation (16) by using the equation (18A) and the equation (18B).

$$\begin{matrix}[ Mathematical 25 ] & \\ {r}^{*} \frac{{d}^{2} Θ}{{dr}^{* 2}} + \frac{d Θ}{{dr}^{*}} + {r}^{*} \frac{hR}{{k}_{r}} \frac{R}{d} Θ = 0 & ( 19 )\end{matrix}$$

A Biot number Biᵣ in the radial direction is defined in the following equation.

$$\begin{matrix}[ Mathematical 26 ] & \\ {Bi}_{r} = \frac{hR}{{k}_{r}} & ( 20 )\end{matrix}$$

A design parameter a is defined in the following equation from the Biot number Biᵣ.

$$\begin{matrix}[ Mathematical 27 ] & \\ a = {Bi}_{r} \frac{R}{d} & ( 21 )\end{matrix}$$

Herein, R [m] is a radius of the heat source 11. As described above, d [m] is a thickness of the heat diffusion plate 10. Further, a is set as a ratio of the radius r of the heat diffusion plate 10 to the radius R of the heat source 11.

$$\begin{matrix}[ Mathematical 28 ] & \\ {r}^{*} \frac{{d}^{2} Θ}{{dr}^{* 2}} + \frac{d Θ}{{dr}^{*}} + {ar}^{* 2} Θ ( {r}^{*} ) = 0 & ( 22 )\end{matrix}$$

The following equation is acquired as a general solution of the equation (22) described above.

$$\begin{matrix}[ Mathematical 29 ] & \\ Θ ( {r}^{*} ) = {C}_{1} {I}_{0} ( \sqrt{a} {r}^{*} ) + {C}_{2} {K}_{0} ( \sqrt{a} {r}^{*} ) & ( 23 )\end{matrix}$$

Herein, I₀ is a zeroth-order modified Bessel function of a first kind. K₀ is a zeroth-order modified Bessel function of a second kind.

The equation (22) described above being differentiated is as in the following equation.

$$\begin{matrix}[ Mathematical 30 ] & \\ \frac{d Θ}{{dr}^{*}} = \sqrt{a} \{ {C}_{1} {I}_{1} ( \sqrt{a} {r}^{*} ) + {C}_{2} {K}_{1} ( \sqrt{a} {r}^{*} ) \} & ( 24 )\end{matrix}$$

Herein, I₁ is a first-order modified Bessel function of a first kind. K₁ is a first-order modified Bessel function of a second kind.

As illustrated in FIG. 4, the first surface S1 can be divided into the following two regions.

Region (Zone) I (0≤r≤R): Central region where heat is transmitted from a bottom surface
Region (Zone) II (R≤r): Peripheral region where heat is not transmitted from the bottom surface

In the region I, a second term of the equation (22) diverges to +∞ as r* approaches+0. Since Θ^{I}(r) is a bounded function, C₂ needs to be 0. Then, the second term of the equation (22) in the region I becomes 0. Further, Θ^{I}(r*) becomes 1 when r*=1, and is as in the following equation.

$$\begin{matrix}[ Mathematical 31 ] & \\ {Θ}^{I} ( {r}^{*} ) = \frac{{I}_{0} ( \sqrt{a} {r}^{*} )}{{I}_{0} ( \sqrt{a} )} & ( 25 )\end{matrix}$$

Furthermore, Θ^{II}(r*) is derived as follows from a boundary condition of an end portion (r*=α) of the heat diffusion plate 10 by the Newton's law and various boundary conditions such as a case where Θ^{II}=1 when r*=1.

$$\begin{matrix}[ Mathematical 32 ] & \\ {Θ}^{II} ( {r}^{*} ) = \frac{\begin{matrix}\{ \sqrt{a} {K}_{1} ( \sqrt{a} α ) - {Bi}_{r} {K}_{0} ( \sqrt{a} α ) \} {I}_{0} ( \sqrt{a} {r}^{*} ) + \\ \{ \sqrt{a} {I}_{1} ( \sqrt{a} α ) + {Bi}_{r} {I}_{0} ( \sqrt{a} α ) \} {K}_{0} ( \sqrt{a} {r}^{*} )\end{matrix}}{\begin{matrix}\{ \sqrt{a} {K}_{1} ( \sqrt{a} α ) - {Bi}_{r} {K}_{0} ( \sqrt{a} α ) \} {I}_{0} ( \sqrt{a} ) + \\ \{ \sqrt{a} {I}_{1} ( \sqrt{a} α ) + {Bi}_{r} {I}_{0} ( \sqrt{a} α ) \} {K}_{0} ( \sqrt{a} )\end{matrix}} & ( 26 )\end{matrix}$$

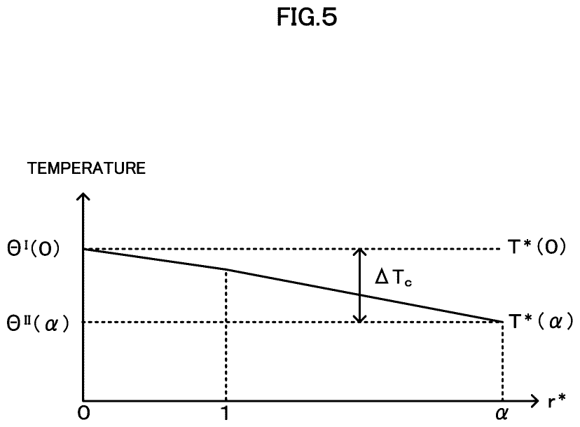

As illustrated in FIG. 5, in the heat diffusion plate 10, a maximum point of temperature in the surface is a central portion in contact with a central portion of the heat source 11, and is given by Θ^{I}(0). A minimum point of temperature is an end portion (r=αR) of the heat diffusion plate 10, and is given by Θ^{II}(α). Therefore, a value of a value ΔΘ of dimensionless temperature unevenness in the surface is given by the following equation.

$$ΔΘ = {Θ}^{I} ( 0 ) - {Θ}^{II} ( α ) \qquad [ Mathematical 33 ]$$

Θ^{I}(0) and Θ^{II}(α) can be decided by the equation (25) and the equation (26), respectively.

After Θ^{I}(0) and Θ^{II}(α) are decided, the surface temperature T*(r*) [K] of the first surface S1 at each point when r*=0 and r*=a are each as follows by the equation (18A).

$$\begin{matrix}[ Mathematical 34 ] & \\ {T}^{*} ( 0 ) = T ( 0 ) - {T}_{∞} - \frac{{q}_{in}}{h} = {Θ}^{I} ( 0 ) {T}_{R}^{*} = {Θ}^{I} ( 0 ) \{ T ( R ) - {T}_{∞} - \frac{{q}_{in}}{h} \} & ( 27 )\end{matrix}$$

$$\begin{matrix}[ Mathematical 35 ] & \\ {T}^{*} ( α ) = T ( α ) - {T}_{∞} - \frac{{q}_{in}}{h} = {Θ}^{II} ( α ) {T}_{R}^{*} = {Θ}^{II} ( α ) \{ T ( R ) - {T}_{∞} - \frac{{q}_{in}}{h} \} & ( 28 )\end{matrix}$$

The value ΔT∞ of temperature unevenness in the surface of the first surface S1 is given by the following equation.

$$\begin{matrix}[ Mathematical 36 ] & \\ Δ T = {T}^{*} ( 0 ) - {T}^{*} ( α ) = T ( 0 ) - T ( α ) = \{ {Θ}^{I} ( 0 ) - {Θ}^{II} ( α ) \} \{ T ( R ) - {T}_{∞} - \frac{{q}_{in}}{h} \} & ( 29 )\end{matrix}$$

Herein, it is assumed that a target temperature of the control subject CO is a boundary condition T(R) of temperature of the heat diffusion plate 10, an ambient temperature around the control subject CO is T, and an input heat flux is qᵢₙ. The values can be set as given design conditions. Further, Θ^{I}(0) and Θ^{II}(α) are decided when a, a, and the Biot number Biᵣ are decided. α is decided when a radius of the heat diffusion plate 10 and the heat source 11 is decided, and a is decided when d, R, and the Biot number Biᵣ are decided.

Therefore, in the design method, when values of T(R), T∞, and qᵢₙ are set as the given design conditions, and, furthermore, values of design parameters d, R, and a related to a size of the heat diffusion plate 10 and the heat source 11 are decided, a value of an upper limit value Bi_{r.MAX} of the Biot number Biᵣ satisfying ΔT=ΔT_{c} can be decided from the equation (29) as illustrated in FIG. 5.

When the value of the upper limit value Bi_{r.MAX} of the Biot number Biᵣ is obtained, a design condition of the temperature control device 1 can be determined by deciding the heat conductivity kᵣ and the overall heat transfer coefficient h in the surface direction of the heat diffusion plate 10 in such a way as to satisfy the following equation (30).

$$\begin{matrix}[ Mathematical 37 ] & \\ \frac{hR}{{k}_{r}} < {Bi}_{r , MAX} & ( 30 )\end{matrix}$$

Therefore, the equation (29) and the equation (30) are calculation equations indicating a relationship among the ambient temperature T∞ around the control subject CO, the target temperature T(R) of the control subject CO, the input heat amount qᵢₙ from the heat source 11 to the heat diffusion plate 10, values of the design parameters d, R, and a related to the size of the heat diffusion plate 10 and the heat source 11, the heat conductivity kᵣ and the overall heat transfer coefficient h of the heat diffusion plate 10, and the permissible value ΔT_{c} of variations in the relationship with the temperature T∞ [K] on the first surface S1, and values of the design parameters d, R, α, kᵣ, and h can be decided by using the equation (29) and the equation (30).

### [Flow of Design of Temperature Control Device 1]

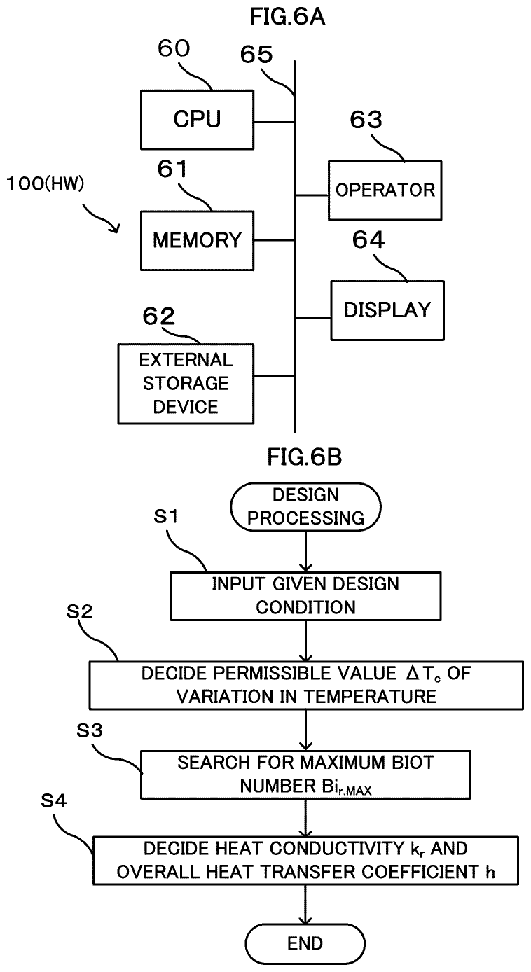

As illustrated in FIG. 6A, design of the temperature control device 1 is performed by an information processing device 100. The information processing device 100 is achieved by a CPU 60 executing a software program read from an external storage device 62 into a memory 61 according to an operation via an operator 63 in a computer HW including the CPU 60, the memory 61, the external storage device 62, the operator 63, a display 64, and an internal bus 65. An execution result of design processing of the temperature control device 1 by the CPU 60 is displayed on, for example, the display 64. The information processing device 100 having the function achieved by the computer executing the program performs the design processing (design method) of the temperature control device 1 illustrated in FIG. 6B.

As illustrated in FIG. 6B, first, the information processing device 100 inputs given design conditions such as the ambient temperature T∞ around the control subject CO, the input heat amount qᵢₙ from the heat source 11, the target temperature T(R) of the control subject CO, and values of the design parameters d, R, and a related to a size of the heat diffusion plate 10 and the heat source 11 (step S1).

Next, the information processing device 100 decides the permissible value ΔTᵣ of temperature unevenness corresponding to the variations Δr_{c} of a reaction value, based on the relationships indicated in the equation (1) to the equation (8), also obtains ΔT_{pc.i} satisfying Δφ_{pc.i} from f_{pc.i}(T), based on the equation (9) and the equation (10), and decides a minimum value from ΔTᵣ and ΔT_{pc.i} as the permissible value ΔT_{c} of variations in temperature (step S2). In other words, the information processing device 100 sets a permissible value of in-surface variations in temperature of the control subject CO, based on a temperature characteristic of a physical property value of the control subject CO or a characteristic of a reaction rate in the surface when the control subject CO is a reaction field.

Next, the information processing device 100 searches for the maximum Biot number Bi_{r.MAX} when ΔT=T_{c} by using the equation (29) described above (step S3). The maximum Biot number Bi_{r.MAX} is a Biot number Bi when ΔT=T_{c}. For example, the bisection method is used for a search for the maximum Biot number Bi_{r.MAX}.

In the bisection method, F=ΔT∞−ΔT_{C} is defined as an evaluation function. At this time, F is a monotone increasing function related to Bi. The bisection method is executed by the following procedures.

Procedure 1) When a value of F from a value in the equation (29) being obtained by giving, as an initial value of both ends of a solution section of the Biot number Biᵣ, a sufficiently small appropriate Biot number Biᵣ₁ (for example, 10⁻⁶) and a sufficiently great appropriate Biot number Biᵣ₂ (for example, 10⁶) and substituting the Biot number Biᵣ₁, that is, F(Biᵣ₁) is not a negative value, a value of Biᵣ₁ continues to be divided by 2 until F(Biᵣ₁) is a negative value. When F(Biᵣ₂) is a negative value, a value of Biᵣ₂ continues to be doubled until a value of F(Biᵣ₂) is positive.

Procedure 2) A value of F in an intermediate value Biᵣₘ=(Biᵣ₁+Biᵣ₂)/2 between Biᵣ₁ and Biᵣ₂, that is, F(Biᵣₘ) is calculated by using the equation (29). The solution section is updated by the following rules by whether a value of F(Biᵣₘ) is positive or negative.

When φ(Biᵣₘ)<0, Biᵣₘ is set as a new Biᵣ₁.
When φ(Biᵣₘ)≥0, Biᵣₘ is set as a new Biᵣ₂.
Procedure 3) Biᵣₘ is obtained from Biᵣ₁ and Biᵣ₂ being newly decided.

Procedure 4) The procedure 2 to the procedure 3 are repeated until Biᵣ₂-Biri falls below a threshold value (for example, 10⁻⁶).

Procedure 5) A final value of Biᵣₘ is set as a search result of a convergent value of the maximum Biot number Bi_{r.MAX}, and the search for the maximum Biot number Bi_{r.MAX} ends.

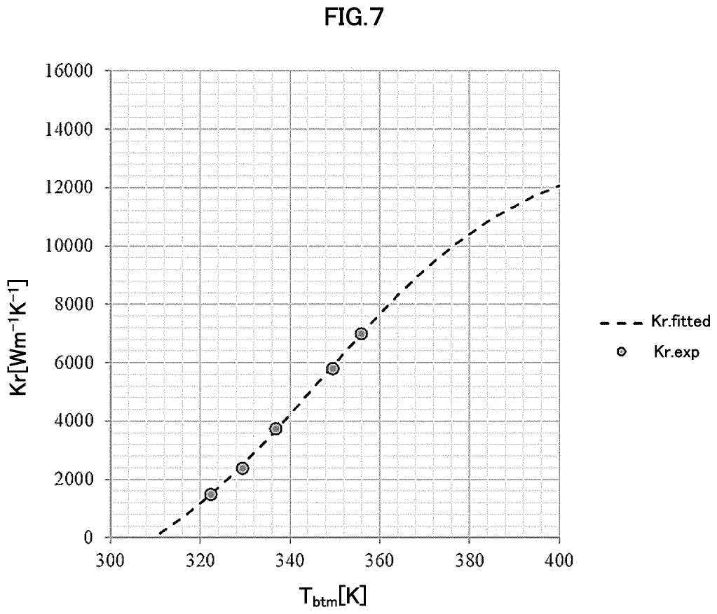

Next, the information processing device inputs the value of the maximum Biot number Bi_{r.MAX} in the equation (30), and decides the heat conductivity kᵣ and the overall heat transfer coefficient h satisfying the equation (30) (step S4). Note that the heat conductivity kᵣ can be set as the heat conductivity kᵣ corresponding to the target temperature T(R) of the control subject CO by using, for example, the temperature characteristic illustrated in FIG. 7.

Note that, in the present embodiment, the Biot number Biᵣ is set as a search subject, but the heat conductivity kᵣ corresponding to the target temperature T(R) of the control subject CO may be first decided based on the temperature characteristic illustrated in FIG. 7, the overall heat transfer coefficient h may be searched as described above, and the maximum Biot number Bi_{r.MAX} may be obtained. Not only the Biot number Biᵣ, but also any of the radius R of the heat source 11, the thickness d of the heat diffusion plate 10, and the ratio α of a radius of the heat diffusion plate 10 to a radius of the heat source 11 may be set as a search subject.

### (Design Example)

For example, design conditions are assumed to be determined as follows.

A diameter 2R of the heat source 11: 55 mm
A diameter (2αR) of the heat diffusion plate 10 and the control subject CO: 30 mm
A permissible value ΔT_{C} of in-surface temperature unevenness: 0.1 K
A target temperature T(R) of the control subject CO: 350 K
An environmental temperature (surrounding ambient temperature) T∞: 298 K

When this condition is input to the equation (29), a value of the maximum Biot number Bi_{r.MAX} is 2.321×10⁻³². Furthermore, a minimum value of the heat conductivity kᵣ satisfying the condition of the maximum Biot number Bi_{r.MAX} is 1.185×10³ [W·m¹·K⁻¹]. Temperature dependence of the heat conductivity kᵣ of the heat diffusion plate 10 made of ceramics is given in FIG. 7. In FIG. 7, kr.exp is an experimental value, and kr.fitted is a fitting curve indicating a characteristic. Herein, a value of the heat conductivity kᵣ in a heat transfer body temperature T_{btm}350 [K] corresponding to the given design condition is 5.987×10³ [W·m⁻¹·K⁻¹]. This value is greater than a minimum value (value corresponding to the maximum Biot number Bi_{r.MAX}) in which kᵣ needs to satisfy, and this value satisfies a necessary condition. Note that, since a value of temperature unevenness in the surface of the control subject CO at that time is 0.0201 [K], it is obvious that the heat diffusion plate 10 can achieve temperature unevenness of the control subject CO equal to or less than a permissible value.

As described above in detail, according to the present embodiment, the radius R in which the heat source 11 and the heat diffusion plate 10 are in contact, the radius ratio α between the heat diffusion plate 10 and the circular region 11a, the plate thickness d of the heat diffusion plate 10, and the heat conductivity kᵣ and the overall heat transfer coefficient h of the heat diffusion plate 10 can be decided in such a way that a difference between the maximum temperature T*(0) and the minimum temperature T*(a) on the first surface S1 in contact with the control subject CO is set within the permissible value ΔT_{c}, and thus variations in temperature of the control subject CO can be suppressed within a permissible value.

### Modified Example of Configuration

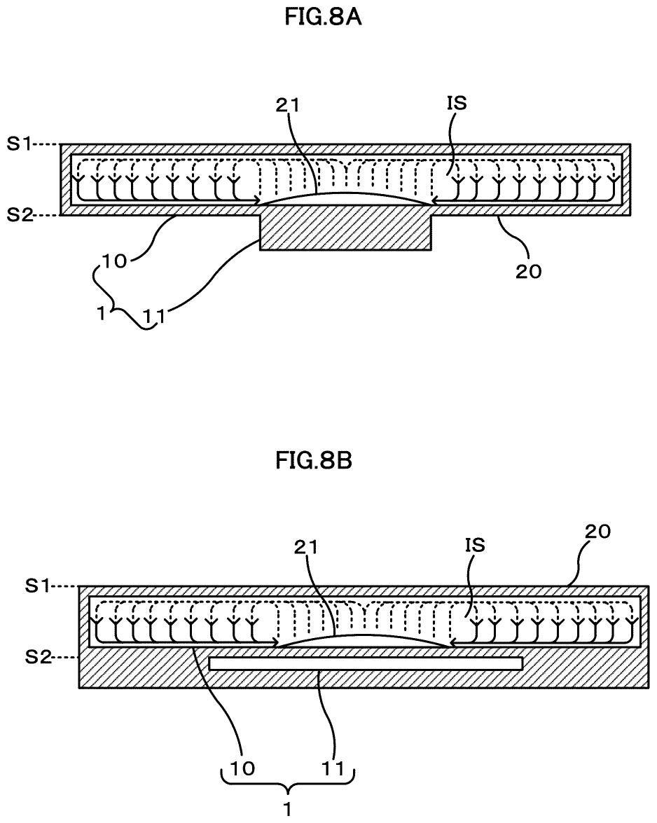

Note that a configuration of the temperature control device 1 is not limited to the configuration illustrated in FIG. 1. For example, as illustrated in FIG. 8A, the heat source 11 and the heat diffusion plate 10 may be integral in the second surface S2. Specifically, the housing 20 of the heat source 11 and the housing 20 of the heat diffusion plate 10 can be made of the same material, and the heat source 11 and the housing 20 of the heat diffusion plate 10 can be directly bonded on the second surface S2 and be integral. Further, the heat source 11 may be provided by screen-printing a heater circuit on a ceramics substrate, and the heat diffusion plate 10 and the heat source 11 may be integral by simultaneous sintering.

The heat source 11 may be incorporated in the heat diffusion plate 10. In this case, as illustrated in FIG. 8B, a heater layer to be the heat source 11 is incorporated in the housing 20 of the heat diffusion plate 10.

### [Substrate Holding Device]

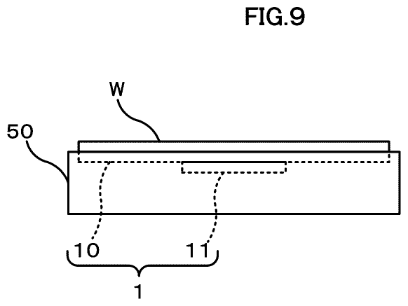

The configuration of the temperature control device 1 according to the present embodiment can be applied to a substrate holding device in an electrostatic adsorption manner and a vacuum adsorption manner. As illustrated in FIG. 9, a substrate holding device 50 includes the temperature control device 1. The temperature control device 1 is provided with a function of controlling a temperature of a wafer W and also adsorbing the wafer W in the electrostatic adsorption manner or the vacuum adsorption manner. In this way, variations in a temperature T in a surface of the wafer W can be set within a permissible value in exposure processing, development processing, etching processing, and the like executed on the wafer W. Note that the temperature control device 1 can also be incorporated in a substrate holding device that holds a liquid crystal substrate other than the wafer W or the other substrate.

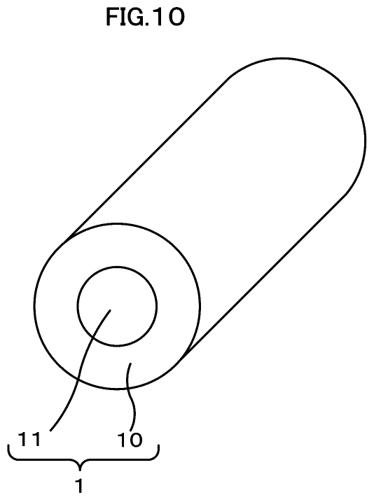

Further, the temperature control device 1 according to the present embodiment has a disk shape, but is not limited to this, and may have, for example, a polygonal flat plate shape. Further, the temperature control device 1 is not limited to a planar shape. For example, as illustrated in FIG. 10, the temperature control device 1 may have a columnar shape and the like. In this case, the heat source 11 has a columnar shape, and the heat diffusion plate 10 having a cylindrical shape is provided in such a way as to be in contact with a side surface of the heat source 11. A side surface of the heat diffusion plate 10 is in contact with the control subject CO, and controls a temperature of the control subject CO. When the temperature control device 1 has a polygonal flat plate shape, a plane passing through the center of the heat source 11 and including the z axis is considered. When the plane is rotated about the z axis, a length of a line segment crossing the heat source 11 changes in accordance with the rotation. In such a temperature control device 1, a heat flux flowing into the heat diffusion plate 10 is maximum in the above-described plane in which a length of the line segment crossing the heat source 11 is the shortest. Therefore, in the plane in which the heat flux is maximum, the above-described equation may be applied, and an evaluation of safety may be performed by performing heat design.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2022-189258, filed on Nov. 28, 2022, the entire disclosure of which is incorporated by reference herein.

### INDUSTRIAL APPLICABILITY

The present disclosure can be applied for making a temperature of a substance or a reaction field spreading in a surface direction uniform.

### REFERENCE SIGNS LIST

1 Temperature control device
10 Heat diffusion plate
11 Heat source
11a Region
20 Housing
21 Working fluid
50 Substrate holding device
60 CPU
61 Memory
62 External storage device
63 Operator
64 Display
65 Internal bus
100 Information processing device
CO Control subject
IS Internal space
S1 First surface
S2 Second surface
HW Computer
W Wafer

1. A design method of a temperature control device, the temperature control device including a heat diffusion plate that is a member provided with a first surface facing a control subject and a second surface being parallel to the first surface and facing in an opposite direction, and diffuses heat in a surface direction of the first surface, and a heat source that is thermally bonded to the heat diffusion plate on the second surface, and performs heating or heat-absorbing on the heat diffusion plate, the design method comprising:
deciding a size of the heat diffusion plate and the heat source, and heat conductivity and an overall heat transfer coefficient of the heat diffusion plate, based on a calculation equation indicating a relationship among an ambient temperature around the control subject, a target temperature of the control subject, an input heat amount from the heat source to the heat diffusion plate, the size of the heat diffusion plate and the heat source, the heat conductivity and the overall heat transfer coefficient of the heat diffusion plate, and variations in temperature on the first surface, in such a way that a difference between a maximum temperature and a minimum temperature of a portion of the first surface in contact with the control subject when the ambient temperature, the target temperature, and the input heat amount are set as given design conditions falls within a permissible value of in-surface variations in temperature of the control subject.

2. The design method according to claim 1, wherein the heat diffusion plate includes
a housing that has a hermetically sealed internal space, and is made of any of ceramics, a ceramics composite material, and an inorganic substance except for metal, and
a working fluid that is located in the internal space, circulates in the internal space in the surface direction of the first surface while repeating vaporization by heat reception and condensation by heat radiation, and diffuses heat in the surface direction of the first surface.

3. The design method according to claim 2, wherein a heat expansion coefficient of a substance of the housing is equal to or less than 8.0×10⁻⁶ [1/K].

4. The design method according to claim 1, further comprising:
setting a permissible value of in-surface variations in temperature of the control subject, based on a temperature characteristic of a physical property value of the control subject or a characteristic of a reaction rate in the surface of the control subject when the control subject is a reaction field.

5. The design method according to claim 1, wherein the heat source is any of a heater, a Peltier element, and a cold plate.

6. The design method according to claim 1, wherein the heat source and the heat diffusion plate are integral in the second surface.

7. The design method according to claim 1, wherein the heat source is incorporated in the heat diffusion plate.

8. The design method according to claim 1, wherein
the heat source and the heat diffusion plate each have a disk-shaped outer shape and are also disposed concentrically, and
a radius of the heat source is smaller than a radius of the heat diffusion plate.

9. A temperature control device being designed by using the design method according to claim 1.
